(19) United States
(12) Patent Application Publication
(10) Pub. No.: US 2026/0294188 A1
(43) Pub. Date: Oct. 1, 2026

(54) Cleaning Device and Dust Collecting Method

(71) Applicant: SHENZHEN CHENBEI TECHNOLOGY CO., LTD., SHENZHEN (CN)

(72) Inventors: Junping Li, SHENZHEN (CN); Peng Sun, SHENZHEN (CN); Guorui Zhang, SHENZHEN (CN)

(73) Assignee: SHENZHEN CHENBEI TECHNOLOGY CO., LTD., SHENZHEN, GD (CN)

(21) Appl. No.: 18/880,264

(22) PCT Filed: Sep. 19, 2024
(86) PCT No.: PCT/CN2024/119627

§ 371 Date: Dec. 30, 2024

(30) Foreign Application Priority Data
Sep. 20, 2023 (CN) 202311223284.6
Sep. 12, 2024 (CN) 202411284476.2

(51) Int. Cl. A47L 9/14; A47L 9/00; A47L 9/16; A47L 9/24; B04C 5/185; B04C 9/00

(52) U.S. Cl. CPC A47L 9/149; A47L 9/0063; A47L 9/1608; A47L 9/1683; A47L 9/248; B04C 5/185; B04C 9/00; B04C 2009/005

(57) ABSTRACT

A cleaning device includes a dust suck assembly, a dust suck assembly and a first suck power source. The dust suck assembly includes a dust cup which includes a cup body and a cover movably connected to the cup body. The cup body and the cover constitute a first dust collecting chamber. The dust collecting assembly includes a second dust collecting chamber. The first suck power source is arranged in the dust suck assembly or the dust collecting assembly, and is configured to generate negative pressure in the second dust collecting chamber. The cover is configured to open relative to the cup body under the triggering of the negative pressure, to interconnect the first dust collecting chamber and the second dust collecting chamber. The dust cup interconnects with the second dust collecting chamber during dust collection.

### CROSS-REFERENCE TO RELATED APPLICATIONS

This application claims the benefit of the priority filing date of PCT application number PCT/CN2024/119627, filed on Sep. 19, 2024, which claims the benefit of the priority filing dates of Chinese patent Applications No. 202411284476.2, filed on Sep. 12, 2024, and 202311223284.6, filed on Sep. 20, 2023, both of which are entitled “Cleaning Device and Dust Collecting Method,” and which are hereby incorporated in their entirety into the present disclosure.

### FIELD

The present invention relates to the field of cleaning technology, in particular to a cleaning device and a dust collecting method.

### BACKGROUND

A cleaning device is configured to suck dust and garbage on the ground into a dust cup by sucking air to keep the ground clean. The cleaning device is provided with a dust collecting station to collect the dust and garbage in the dust cup. In the related art, when the cleaning device is placed on the dust collecting station, the dust cup bottom cover is opened by the action of a top rod or a lug on the dust collecting station, and the dust in the dust cup may fall freely into the dust collecting station. However, there is a problem in this process that the dust and garbage in the dust cup cannot completely enter the dust collecting station.

### SUMMARY

Based on this, it is necessary to provide a cleaning device so that dust and garbage in the dust cup can be completely discharged.

A cleaning device includes a dust suck assembly, a dust collecting assembly and a first suck power source; the dust suck assembly includes a dust cup, the dust cup includes a cup body and a cover movably connected to the cup body, the cup body and the cover constitute a first dust collecting chamber; the dust collecting assembly includes a second dust collecting chamber; the first suck power source is provided in the dust suck assembly or the dust collecting assembly, and is configured to form a negative pressure in the second dust collecting chamber, and the cover is configured to open relative to the cup body under the triggering of the negative pressure, so that the first dust collecting chamber and the second dust collecting chamber are interconnected; during dust collection, the dust cup interconnects with the second dust collecting chamber.

It can be understood that setting the first dust collecting chamber facilitates the collecting of dust and garbage when the cleaning device performs dust suck and cleaning; setting the second dust collecting chamber facilitates the collecting of dust and garbage in the first dust collecting chamber, so that the first dust collecting chamber can continue to normally contain dust and garbage when the cleaning device performs subsequent cleaning. During the dust collecting process of the second dust collecting chamber, the first suck power source can extract the air in the second dust collecting chamber, so that the air pressure in the second dust collecting chamber is lower than the air pressure in the first dust collecting chamber, and the cover is opened under the action of the air pressure in the first dust collecting chamber, and the air in the first dust collecting chamber may be concentrated and flow into the second dust collecting chamber. A relatively large air pressure can drive the dust and garbage in the first dust collecting chamber to completely enter the second dust collecting chamber, so as to achieve complete discharge of dust and garbage in the dust cup, which is conducive to improving the dust collecting efficiency.

In one embodiment, along a radial direction of the dust cup, the cover has a first end and a second end arranged opposite to each other, the first end is movably connected to the cup body, and the second end can be opened relative to the cup body under the triggering of the negative pressure.

It is understandable that under the action of the air pressure in the first dust collecting chamber, the second end is opened relative to the cup body, and the first end of the cover is movably connected to the cup body to maintain connection with the cup body, so as to facilitate the second end continuing to be connected to the cup body.

In one embodiment, the first end is rotatably connected to the cup body, and the second end is snap-fitted to the cup body, and the second end is configured to unlock the cup body in response to the pressure difference, between the first dust collecting chamber and the second dust collecting chamber, reaching the first pressure difference.

It is understandable that the snap-connection method is easy to unlock, and the air pressure in the first dust collecting chamber acts on the snap-connection to break the lock formed by the snap. At the same time, the snap-connection method is also convenient for re-snapping after unlocking, and the operation is simple.

In one embodiment, the dust suck assembly includes a locking mechanism, the locking mechanism is rotatably connected to the cup body, the locking mechanism includes an elastic portion and a first abutting portion which are spaced apart, the elastic portion and the first abutting portion are arranged at both ends of the rotating shaft of the locking mechanism, the elastic portion is elastically connected to the cup body, and the first abutting portion is snap-fitted with the cover.

It can be understood that the locking mechanism is provided to facilitate the snap connection. The first abutting portion can be tightly snapped with the cover under the action of the elastic force of the elastic portion, and the cover is effectively limited and locked. Under the action of negative pressure, the first abutting portion is unlocked from the cover. At the same time, the elastic portion can reset the first abutting portion by elastic force when there is no air pressure, so as to re-lock the cover.

In one embodiment, the first abutting portion has an abutting surface, and the cup body radial direction and the cup body axial direction are respectively angled with the abutting surface; the cover has a matching surface, and the matching surface can be fitted with the abutting surface to be locked, and the abutting surface is configured to rotate around the rotating shaft to move away from the matching surface in response to the first pressure difference.

It can be understood that a mechanical limit is formed by the fitting of the abutting surface and the matching surface, which is effective and reliable. The abutting surface rotates around the rotating shaft under the action of the first air pressure to unlock the cover, which is simple to operate.

In one embodiment, during the dust collection; an air inlet is configured to open in response to the opening of the cover, and the air inlet can be in communication with the first dust collecting chamber and the second dust collecting chamber.

It can be understood that before the cover is opened, the air inlet is closed so that the first suck power source can extract the air in the second dust collecting chamber to form a negative pressure. After the cover is opened, the air inlet is also opened, so that the first suck power source can suck external air through the air inlet. The external air passes through the bottom of the first dust collecting chamber and further brings the dust into the second dust collecting chamber, further promoting the dust collecting efficiency.

In one embodiment, the first suck power source is provided in the dust suck assembly; the dust suck assembly further includes a first airway and a second airway, the first airway is located in the dust cup, and the second airway is located outside the dust cup; the cleaning device has a dust suck stage and a dust collecting stage; during vacuum, the air inlet of the dust suck assembly, the first airway, the first suck power source and the first air outlet are interconnected; during dust collection, the second dust collecting chamber, the second airway, the first suck power source and the first air outlet are interconnected.

It can be understood that two different airways are provided to meet the needs under different working conditions. Specifically, under the working condition of the dust suck stage, the first suck power source can suck the external air through the air inlet, and after the external air passes through the first airway, the dust in the air falls into the dust cup, and the air is separated from the dust and discharged from the first air outlet through the first suck power source. During dust collection, the first suck power source can extract the air in the second dust collecting chamber through the second airway to form a negative pressure, and the air in the second dust collecting chamber is discharged from the air outlet of the cleaning device after passing through the second airway and the first suck power source.

In one embodiment, the dust suck assembly includes an airway switching assembly, which is installed between the first airway and the second airway, and the airway switching assembly is configured to switch one of the first airway and the second airway to open and the other to close.

It can be understood that the airway switching assembly is set to switch the first airway and the second airway, so as to meet the requirements of different airways during vacuum and the dust collecting stage.

In one embodiment, the airway switching assembly includes a rotating cover, the rotating cover has a rotating shaft, and the portion on one side of the rotating shaft along the radial direction of the rotating shaft is defined as a first blocking portion, and the other side is defined as a second blocking portion; the first blocking portion is configured to block the first airway, and the second blocking portion is configured to block the second airway, and the rotating cover switches between the first blocking portion and the second blocking portion by rotating around the rotating shaft.

It can be understood that by rotating the rotating cover around the rotating shaft, the first blocking portion can be switched to block the first airway, and the second airway is opened at this time to facilitate dust collecting; by switching the second blocking portion to block the second airway, the first airway is opened at this time to facilitate dust suck. Such a structure is simple and convenient for switching operation.

In one embodiment, the cleaning device includes a cyclone separation structure, the cyclone separation structure is installed in a dust cup, an inner cavity of the cyclone separation structure is in communication with the dust cup and forms the first airway; a channel between the dust cup and the air inlet of the dust collecting assembly forms the second airway.

It is understandable that the inner cavity of the cyclone separation structure can form the first airway to facilitate the passage of air, and at the same time, the cyclone separation structure can separate the dust in the air from the air, so that the dust falls into the dust cup.

In one embodiment, the airway switching assembly includes a first elastic member, which is installed between the first blocking portion and the cyclone separation structure; the airway switching assembly also includes a top contact member, one end of which is connected to the second blocking portion; the first elastic member is configured to lift the first blocking portion in response to the separation of the dust suck assembly from the dust collecting assembly; the top contact member is configured to lift the second blocking portion in response to the right connection of the dust suck assembly and the dust collecting assembly.

It can be understood that the first elastic member has an elastic force on the first blocking part. During vacuum, the dust suck assembly and the dust collecting assembly, the first elastic member can push up the first blocking part by its own elastic force to open the first airway. At this time, the second blocking part blocks the second airway downward; after the dust suck assembly and the dust collecting assembly are rightly connected, the top contact member pushes up the second blocking part to open the second airway. At this time, the first blocking part has a downward pressure on the first elastic member, thereby blocking the first airway.

In one embodiment, the dust collecting assembly is also provided with a second abutting portion, and during dust collection, the second abutting portion abuts against the top contact member.

It can be understood that the second abutting portion is provided so that when the dust collecting assembly interconnects with the dust collecting assembly, the second abutting portion can push the top contact member upward, thereby pushing the second blocking part up, thereby opening the second airway.

In one embodiment, the first suck power source is provided in the dust collecting assembly, and the first suck power source is in communication with the second air outlet.

It is understandable that such a configuration facilitates the first suck power source to directly extract the air in the second dust collecting chamber, and the operation is simple.

The present application also provides a dust collecting method, which is applied to the above-mentioned cleaning device; the dust collecting method comprises: rightly connecting the dust collecting assembly with the dust suck assembly; the first suck power source sucks the air in the second dust collecting chamber of the dust collecting assembly to form a negative pressure in the second dust collecting chamber; the cover is opened under the triggering of the negative pressure, and the first dust collecting chamber and the second dust collecting chamber are interconnected.

It is understandable that by sucking the air in the second dust collecting chamber to form a negative pressure in the second dust collecting chamber, the cover is opened by the negative pressure, and the air in the first dust collecting chamber may drive dust and garbage into the second dust collecting chamber, so as to improve the efficiency of dust collecting.

In one embodiment, that the first suck power source sucks the air in the second dust collecting chamber of the dust collecting assembly to form a negative pressure in the second dust collecting chamber includes: forming a pressure difference between the first dust collecting chamber and the second dust collecting chamber of the dust suck assembly, and the air pressure in the first dust collecting chamber is greater than the air pressure in the second dust collecting chamber; the cover is opened under the negative pressure trigger, including: when the pressure difference between the first dust collecting chamber and the second dust collecting chamber reaches the first pressure difference, the cover is opened.

It can be understood that when the pressure difference between the first dust collecting chamber and the second dust collecting chamber reaches the first pressure difference, the first dust collecting chamber has a sufficiently large air pressure to push the cover to open, so that there is enough impulse to bring the dirt in the first dust collecting chamber into the second dust collecting chamber, so that no dust and garbage are left in the first dust collecting chamber, and the dust collecting efficiency is improved.

In one embodiment, the dust collecting method further includes: before the cover is opened, the air inlet of the dust suck assembly is closed; after the cover is opened, the air inlet is opened, and the air inlet is in communication with the first dust collecting chamber and the second dust collecting chamber.

It can be understood that, in this arrangement, after the cover is opened, the external air can be sucked through the air inlet, and the external air enters the second dust collecting chamber and passes through the bottom of the first dust collecting chamber, and the dust and garbage at the bottom of the first dust collecting chamber can be brought into the second dust collecting chamber to promote dust collecting efficiency.

The present application also provides a dust collecting method, which is applied to a cleaning device, and the cleaning device is provided with a first dust collecting chamber and a second dust collecting chamber that can be selectively communicated, and the cleaning device includes a dust cup, and the dust cup forms the first dust collecting chamber. The dust collecting method includes: suck the air in the second dust collecting chamber to form a negative pressure in the second dust collecting chamber; the cover of the dust cup is opened under the negative pressure, and the first dust collecting chamber and the second dust collecting chamber are interconnected.

It is understood that by sucking the air in the second dust collecting chamber to form a negative pressure in the second dust collecting chamber, the cover is opened by the negative pressure, and the air in the first dust collecting chamber drives dust and garbage into the second dust collecting chamber to improve the efficiency of dust collecting.

In one embodiment, that the suck of the air in the second dust collecting chamber to form a negative pressure in the second dust collecting chamber includes: forming a pressure difference between the first dust collecting chamber and the second dust collecting chamber, and the air pressure in the first dust collecting chamber is greater than the air pressure in the second dust collecting chamber; the cover of the dust cup is opened under the negative pressure, including: when the pressure difference between the first dust collecting chamber and the second dust collecting chamber reaches the first pressure difference, the cover is opened.

It is understood that when the pressure difference between the first dust collecting chamber and the second dust collecting chamber reaches the first pressure difference, the first dust collecting chamber has a sufficiently large air pressure to push the cover to open, so that there is enough momentum to bring the dirt in the first dust collecting chamber into the second dust collecting chamber, so that no dust and garbage are left in the first dust collecting chamber, and the dust collecting efficiency is improved.

In one embodiment, the cleaning device is provided with an air inlet in communication with the first dust collecting chamber, and the dust collecting method further includes: before the cover is opened, the air inlet of the dust suck assembly is closed; after the cover is opened, the air inlet is opened, and the air inlet is in communication with the first dust collecting chamber and the second dust collecting chamber.

It can be understood that, with such a configuration, after the cover is opened, the external air can be sucked through the air inlet, and the external air enters the second dust collecting chamber and passes through the bottom of the first dust collecting chamber, and the dust and garbage at the bottom of the first dust collecting chamber can be brought into the second dust collecting chamber to promote the dust collecting efficiency.

### BRIEF DESCRIPTION OF THE DRAWINGS

In order to more clearly illustrate the technical solutions in the embodiments of the present application or the conventional technology, the drawings required for the description of the embodiments or the conventional technology will be briefly introduced below. Obviously, the drawings described below are only the embodiments of the present application. For ordinary technicians in this field, other drawings can be obtained based on the disclosed drawings without creative work.

FIG. 1 is a cut-away elevation view of a cleaning device provided by the present application in a first embodiment;

FIG. 2 is a cut-away elevation view of a dust suck assembly of the cleaning device provided by the present application in one case in the first embodiment;

FIG. 3 is a partial enlarged view of A in FIG. 2;

FIG. 4 is a partial cut-away elevation view of the airway switching assembly as shown in FIG. 2;

FIG. 5 is a cross-sectional view of the dust suck assembly of the cleaning device provided by the present application in another case in the first embodiment;

FIG. 6 is a partial cut-away view of the airway switching assembly as shown in FIG. 5;

FIG. 7 is a cut-away elevation view of the dust collecting assembly in the first embodiment of the cleaning device provided by the present application;

FIG. 8 is a cut-away elevation view of the structure of a second embodiment cleaning device provided by the present application;

FIG. 9 is a cut-away elevation view of the structure of a third embodiment cleaning device provided by the present application;

FIG. 10 is a cut-away elevation view of a dust suck assembly of the third embodiment cleaning device provided by the present application.

Reference numerals: 100, cleaning device; 1001, first airway; 1002, second airway; 1003, air inlet; 1004, first air outlet; 1005, second air outlet; 1006, return airway; 1007, air inlet duct; 1008, third airway; 10, dust suck assembly; 11, dust cup; 101, first dust collecting chamber; 111, cup body; 112, cover; 1121, first end; 1122, second end; 11221, mating surface; 12, cyclone separation structure; 13, filter cotton; 20, dust collecting assembly; 21, second abutting portion; 22, dust collecting shell; 23, dust collecting bag; 24, dust collecting body; 241, collecting chamber; 25, connecting pipe; 201, second dust collecting chamber; 202, chamber opening; 31, first suck power source; 32, second suck power source; 40, airway switching assembly; 41, rotating cover; 411, rotating shaft; 412, first blocking portion; 413, second blocking portion; 42, second elastic member; 43, top contact member; 50, locking mechanism; 51, first abutting portion; 511, abutting surface; 52, elastic portion; 521, first elastic member; 522, connecting surface; 53, rotating shaft; 61, first shielding structure; 62, second shielding structure; 63, sealing plate; 601, first flow opening; 602, second flow opening.

### DETAILED DESCRIPTION OF THE EMBODIMENTS

The following will combine the drawings in the embodiments of this application to clearly and completely describe the technical solutions in the embodiments of this application. Obviously, the described embodiments are only part of the embodiments of this application, not all of them. Based on the embodiments in this application, all other embodiments obtained by ordinary technicians in this field without creative work are within the scope of protection of this application.

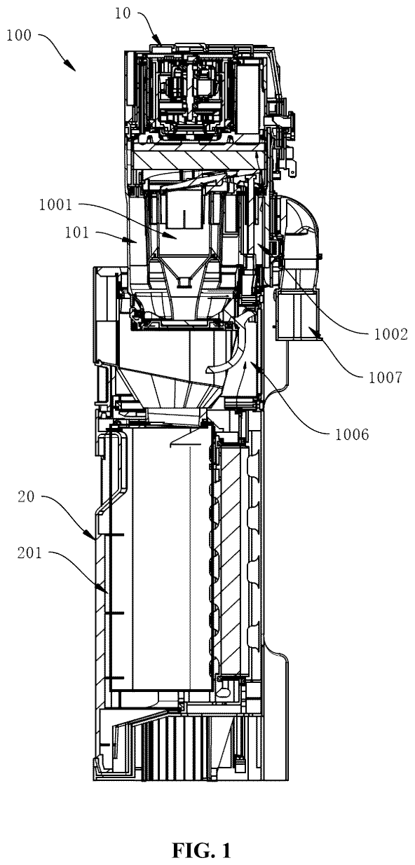

Referring to FIGS. 1 to 10, a cleaning device 100 is provided by the present application, which includes a dust suck assembly 10, a dust collecting assembly 20, and a first suck power source 31; the dust suck assembly 10 includes a dust cup 11, the dust cup 11 includes a cup body 111 and a cover 112 movably connected to the cup body 111, the cup body 111 and the cover 112 constitute a first dust collecting chamber 101; the dust collecting assembly 20 includes a second dust collecting chamber 201; the first suck power source 31 is arranged in the dust suck assembly 10 or the dust collecting assembly 20, and is configured to form a negative pressure in the second dust collecting chamber 201, and the cover 112 is configured to open relative to the cup body 111 under the triggering of the negative pressure, so as to communicate the first dust collecting chamber 101 with the second dust collecting chamber 201; the cleaning device 100 has a dust collecting stage, and during dust collection, the dust cup 11 interconnects to the second dust collecting chamber 201. Specifically, the second dust collecting chamber 201 has a cavity opening 202, and the dust cup 11 interconnects to the second dust collecting chamber 201 through the cavity opening 202.

In this way, the dust suck assembly 10 can suck the air with dust into the first dust collecting chamber 101, separate the dust and the air in the first dust collecting chamber 101, and discharge the clean air from the dust suck assembly 10 while the dust is collected in the dust cup 11. Next, the dust suck assembly 10 interconnects with the dust collecting assembly 20, and the cleaning device 100 starts the dust collecting stage. The air in the second dust collecting chamber 201 can be extracted through the first suck power source 31, so that the air pressure in the second dust collecting chamber 201 is less than the air pressure in the first dust collecting chamber 101, so as to form a pressure difference, and then the air in the first dust collecting chamber 101 applies a force on the cover 112. When the pressure difference reaches a certain value, the air pressure in the first dust collecting chamber 101 causes the cover 112 to open, and the air rushes out of the first dust collecting chamber 101 and can drive the dust into the second dust collecting chamber 201, that is, by forming a negative pressure, the dust can be taken out while the cover 112 is opened, and the structure for opening the cover 112 can be reduced, making the structure of the whole machine simpler. In this process, the air in the first dust collecting chamber 101 has a concentrated and large air pressure, which can completely bring the dust to the second dust collecting chamber 201, and has a good dust collecting effect. In addition, the air in the first dust collecting chamber 101 is concentrated and rushed into the second dust collecting chamber 201, which can reduce the turbulence caused by the air entering the second dust collecting chamber 201 and improve the dust collecting efficiency.

In the embodiment of the present application, the pressure difference between the first dust collecting chamber 101 and the second dust collecting chamber 201 improves the dust collecting efficiency and can make the cover 112 open automatically, so the relevant structure of the cover 112 is first described.

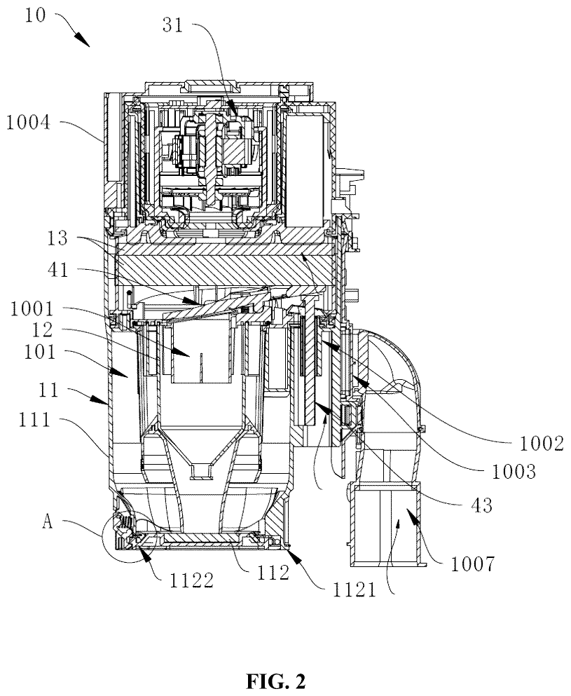

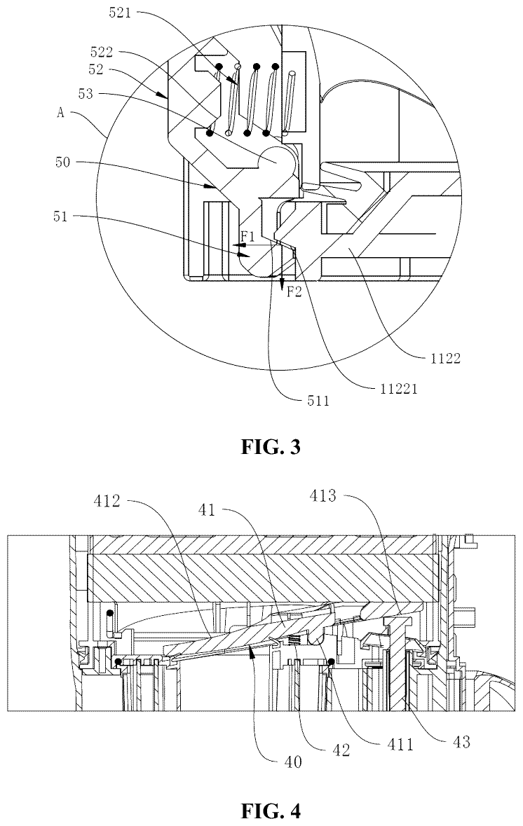

As shown in FIG. 2 and FIG. 3, in an optional embodiment, along the radial direction of the dust cup 11, the cover 112 has a first end 1121 and a second end 1122 arranged relatively to each other, the first end 1121 is movably connected to the cup body 111, and the second end 1122 can be opened relative to the cup body 111 under the triggering of negative pressure. In this way, the air pressure of the first dust collecting chamber 101 can make the second end 1122 relatively far away from the cup body 111, so that the cover 112 can be automatically opened without the cooperation of other structures. After the cover 112 is opened, the first end 1121 can always maintain the connection with the cup body 111, so that after the dust collecting is completed, the second end 1122 only needs to be reconnected to the cup body 111 to achieve the sealing of the cover 112 relative to the cup body 111, so as to facilitate the dust suck work again.

As shown in FIG. 2 and FIG. 3, in a further embodiment, the first end 1121 is rotatably connected to the cup body 111, the second end 1122 is snap-fitted to the cup body 111, and the second end 1122 is configured to unlock the cup body 111 in response to the pressure difference, between the first dust collecting chamber 101 and the second dust collecting chamber 201, reaching the first pressure difference.

In this way, the cup body 111 is locked by the snap connection to limit the cover 112, which is easy to operate and can be unlocked by air pressure. Specifically, when the pressure difference between the first dust collecting chamber 101 and the second dust collecting chamber 201 reaches the first pressure difference, the first dust collecting chamber 101 has a sufficient air pressure to push the cover 112, so that the second end 1122 of the cover 112 gradually separates from the cup 111 under the action of air pressure to achieve the unlocking of the snap connection, and the cover 112 is opened relative to the cup 111, and the cover 112 rotates around the rotation axis of the first end 1121. After dust collecting is completed, the dust suck assembly 10 is separated from the dust collecting assembly 20, and the second end 1122 of the cover 112 can be manually rotated towards the cup 111, and the snap connection with the cup 111 is achieved again under the action of external force. In other embodiments, a pressure sensor may be installed in the dust cup 11. When the pressure sensor senses that the air pressure in the first dust collecting chamber 101 reaches a predetermined value, the cover 112 and the cup 111 may be unlocked.

In some embodiments, when the pressure difference between the first dust collecting chamber 101 and the second dust collecting chamber 201 is set to 4 kPa, the air in the first dust collecting chamber 101 has a sufficient air pressure to open the cover 112. In other embodiments, the corresponding pressure difference value can also be set according to the condition for opening the cover 112, which is not specifically limited here. Further, the first suck power source 31 can perform multiple sucks on the air in the second dust collecting chamber 201 to gradually reach the ideal pressure difference value. Exemplarily, after the first suck power source 31 is turned on and operated for a first period, the first suck power source 31 enters a standby state. After the standby state has lasted for a second period, the first suck power source 31 continues to suck and continues for the first period, and so on and so forth until the start-up and standby actions are repeated n times and then terminated, in which n≥2, n is an integer, for example, n can be set to 2, 3 or 4, as long as the set pressure difference value is satisfied.

As shown in FIGS. 2 and 3, in a specific embodiment, the dust suck assembly 10 includes a lock structure 50, which is rotatably connected to the cup body 111. The lock structure 50 includes an elastic portion 52 and a first abutting portion 51 which are spaced apart. The elastic portion 52 and the first abutting portion 51 are arranged at both ends of the rotation axis 53 of the lock structure 50. The elastic portion 52 is elastically connected to the cup body 111, and the first abutting portion 51 is snap-fitted to the cover 112.

In this way, the snap connection with the cover 112 is realized by installing the lock structure 50 on the cup body 111, and the operation is simple. The lock structure 50 can switch the unlocking and locking of the cover 112 by rotating around the rotation axis 53. The elastic portion 52 moves away from the cup body 111 under the action of the elastic force. Since the elastic portion 52 and the first abutting portion 51 are respectively arranged at the two ends of the rotating shaft 53, the first abutting portion 51 approaches the cover 112 under the action of the elastic force of the elastic portion 52, so as to abut against the cover 112 to achieve locking of the cover 112; under the action of the air pressure in the first dust collecting chamber 101, the first abutting portion 51 can rotate around the circumference of the rotating shaft 53 toward the side away from the cover 112. At this time, the elastic portion 52 has a reverse elastic force, that is, the elastic portion 52 has a tendency to rebound. After the air pressure disappears, the elastic force of the elastic portion 52 is released to reset the first abutting portion 51.

As shown in FIG. 2 and FIG. 3, specifically, the elastic portion 52 includes a connecting surface 522 and a first elastic member 521. The first elastic member 521 is disposed between the connecting surface 522 and the cup body 111. The first elastic member 521 applies an elastic force on the connecting surface 522 in a radial direction away from the cup body 111, so that the locking mechanism 50 rotates along the first circumferential direction around its own rotation axis 53, thereby causing the first abutting portion 51 to move toward the cover 112 and abut against the cover 112 to be locked. After the first abutting portion 51 is unlocked from the cover 112, the first abutting portion 51 rotates around the rotation axis 53 in a direction opposite to the first circumferential direction, applying a squeezing force on the first elastic member 521. Therefore, after the air pressure disappears, the first elastic member 521 rebounds to reset the first abutting portion 51. Exemplarily, the first elastic member 521 can be set as a spring.

As shown in FIG. 2 and FIG. 3, in a more specific embodiment, the first abutting portion 51 has an abutting surface 511, and the cup body 111 is angled with the abutting surface 511 in the radial direction and the axial direction of the cup body 111; the cover 112 has a matching surface 11221, and the matching surface 11221 can fit on the abutting surface 511 to be locked, that is, the abutting surface 511 and the matching surface 11221 are both inclined surfaces, and the abutting surface 511 is configured to rotate around the rotating shaft 53 in response to the first pressure difference to move away from the matching surface 11221. Thus, the cover 112 is limited and supported by the contact surface 511 and the matching surface 11221, which has a large limiting area and sufficient limiting reliability.

As shown in FIG. 3, it should be noted that there is no self-locking angle between the contact surface 511 and the straight line perpendicular to the contact surface 511, so that when the air pressure is transmitted to the contact surface 511, it can be decomposed into a force F1 radially outward along the cup body 111 and a force F2 axially toward the dust collecting assembly 20 along the cup body 111, so that the lock structure 50 has a tendency to rotate toward the first elastic member 521, so that the lock structure 50 can rotate under the push of the air pressure, so that the contact surface 511 is away from the cover 112 to achieve unlocking.

After the dust collecting stage is over, the dust suck assembly 10 is separated from the dust collecting assembly 20, and the cover 112 is manually rotated back to its original position. The cover 112 applies a squeezing force on the lock structure 50 toward the first dust collecting chamber 101, the first elastic member 521 is stretched, and the abutting surface 511 moves toward the first dust collecting chamber 101. When the manual pushing force is large enough, the cover 112 can be slid over the surface of the lock structure 50 and squeezed into the first dust collecting chamber 101. When the hand is released, the mating surface 11221 of the cover 112 and the abutting surface 511 can be locked again.

Next, the present application provides two different embodiments to realize the extraction of air in the second dust collecting chamber 201, which are described in detail below.

### First Embodiment

As shown in FIGS. 1 and 2, in an optional embodiment, the first suck power source 31 is provided in the dust suck assembly 10; the dust collecting assembly 10 further includes a first airway 1001 and a second airway 1002, the first airway 1001 is located in the dust cup 11, and the second airway 1002 is located outside the dust cup 11; the cleaning device 100 has a dust suck stage and a dust collecting stage; during vacuum, the air inlet 1003 of the dust collecting assembly 10, the first airway 1001, the first suck power source 31 and the first air outlet 1004 of the dust suck assembly 10 are connected; during dust collection, the second dust collecting chamber 201, the second airway 1002, the first suck power source 31 and the first air outlet 1004 of the cleaning device 100 are interconnected.

In this way, by setting the first airway 1001 and the second airway 1002 independently of each other to realize the switching of different working conditions, the first suck power source 31 can not only suck the external air during vacuum, but also suck the air in the second dust collecting chamber 201 to form negative pressure for dust collecting during dust collection, achieving the effect of one article for two purposes, so that there is no need to set an additional power source in the cleaning device 100 for air suck, so as to save space.

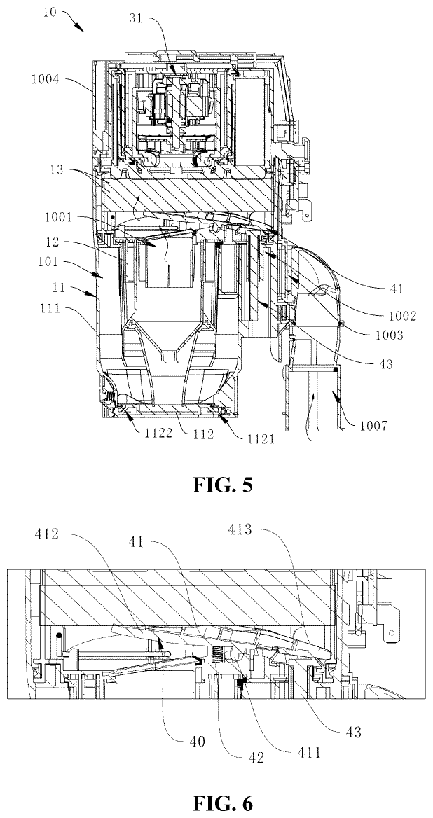

Specifically, as shown in FIG. 5, during vacuum, the first suck power source 31 can suck air into the cleaning device 100 through the air inlet 1003, and the air with dust enters the first airway 1001 from the air inlet 1003, and the dust and air are separated in the first airway 1001, and the clean air is discharged from the first air outlet 1004 through the first suck power source 31 to achieve the cleaning of the dust on the ground. During dust collection, as shown in FIGS. 1, 2 and 7, the air inlet 1003 is initially closed, and the first suck power source 31 can extract the air in the second dust collecting chamber 201. The air in the second dust collecting chamber 201 passes through the second airway 1002, and then passes through the first suck power source 31 and is discharged from the first air outlet 1004, so that the second dust collecting chamber 201 is in a negative pressure state.

In a further embodiment, during the dust collection, the air inlet 1003 is configured to open in response to the opening of the cover 112, and the air inlet 1003 can be in communication with the first dust collecting chamber 101 and the second dust collecting chamber 201. In a specific embodiment, the dust suck assembly 10 further includes an air inlet duct 1007, and the air inlet 1003 is disposed in the air inlet duct 1007, and the air inlet duct 1007 is in communication with the first airway 1001 or the second airway 1002. Thus, during dust collection, before the cover 112 is opened, the air inlet 1003 is in a closed state, so as to form a closed space, so that the air in the second dust collecting chamber 201 is extracted by the first suck power source 31 in the dust suck assembly 10. Further, the cover 112 is opened under the pressure difference between the first dust collecting chamber 101 and the second dust collecting chamber 201, and the air in the first dust collecting chamber 101 drives the dust to enter the second dust collecting chamber 201, thereby realizing the first dust collecting. After the cover 112 is opened, the air inlet 1003 is also opened. At this time, the first suck power source 31 can continue to suck the external air. The external air passes through the bottom of the first dust collecting chamber 101 and enters the second dust collecting chamber 201. Then the air flows from the second dust collecting chamber 201 into the second airway 1002 and flows out from the first air outlet 1004 to bring the dust at the bottom of the first dust collecting chamber 101 into the second dust collecting chamber 201, thereby achieving the second dust collecting. In summary, the dust collecting effect is improved through the impact of two air flows.

As shown in FIG. 1 and FIG. 2, in a further embodiment, the dust collecting assembly 20 further includes a return airway 1006, and the return airway 1006 is communicated between the second dust collecting chamber 201 and the second airway 1002. During dust collection, when the cover 112 is not opened, the air in the second dust collecting chamber 201 enters the second airway 1002 through the return airway 1006 to facilitate the suck of the first suck power source 31. After the cover 112 is opened, the air sucked from the air inlet 1003 passes through the first dust collecting chamber 101 and enters the second dust collecting chamber 201. After dust collecting, the air in the second dust collecting chamber 201 is separated from the dust, and the air passes through the return airway 1006, the second airway 1002 and the first suck power source 31 in sequence, and finally flows out from the first air outlet 1004.

In some embodiments, the first suck power source 31 can be set as a motor, a fan, etc., as long as the air suck is achieved.

As shown in FIG. 2 and FIG. 5, more specifically, the first airway 1001 and the second airway 1002 are spaced apart along the radial direction of the dust cup 11. Along the axial direction of the dust cup 11, filter cotton 13 can be arranged between the first suck power source 31 and the first airway 1001, and between the first suck power source 31 and the second airway 1002 to further filter and remove dust from the air to make the air cleaner. Two layers of the filter cotton 13 can be provided, and the filter cotton 13 can also be replaced with other parts that can filter dust, such as a filter net.

As shown in FIG. 2 and FIG. 5, in some embodiments, the cleaning device 100 includes a cyclone separation structure 12, and the cyclone separation structure 12 is installed in the dust cup 11. The inner cavity of the cyclone separation structure 12 is in communication with the dust cup 11 to form a first airway 1001; the channel between the dust cup 11 and the air inlet 1003 forms a second airway 1002. In this way, the cyclone separation structure 12 can separate the dust and air to purify the air, and the inner cavity of the cyclone separation structure 12 is set as the first airway 1001 to facilitate the separation operation. Specifically, the cyclone separation structure 12 is set as a cyclone cone. When the air and dust touch the side wall of the cyclone cone, the dust may rotate downward along the side wall, and the air may be sucked up under the action of the first suck power source 31, thereby achieving the separation of dust from air.

As shown in FIGS. 2 to 6, in a further embodiment, the cleaning device 100 includes an airway switching assembly 40, which is installed between the first airway 1001 and the second airway 1002. The airway switching assembly 40 is configured to switch one of the first airway 1001 and the second airway 1002 to open and the other to close. In this way, the setting of the airway switching assembly 40 can make it more convenient to switch the first airway 1001 and the second airway 1002. When the cleaning device 100 is during vacuum, the airway switching assembly 40 is controlled to open the first airway 1001, and when the cleaning device 100 is during dust collection, the airway switching assembly 40 is controlled to open the second airway 1002 and close the first airway 1001.

As shown in FIGS. 2 to 6, in a further embodiment, the airway switching assembly 40 includes a rotating cover 41, the rotating cover 41 has a rotating shaft 411, and along the radial direction of the rotating shaft 411, the portion located on one side of the rotating shaft 411 is defined as a first blocking portion 412, and the portion located on the other side is defined as a second blocking portion 413; the first blocking portion 412 is configured to block the first airway 1001, and the second blocking portion 413 is configured to block the second airway 1002. The rotating cover 41 switches between the first blocking portion 412 and the second blocking portion 413 by rotating around the rotating shaft 411, so as to realize the switching of the first airway 1001 and the second airway 1002. Specifically, during vacuum, the rotating cover 41 rotates to the second blocking portion 413 to block the second airway 1002, and at this time, the first blocking portion 412 does not block the first airway 1001 any more, and the first airway 1001 is opened; during dust collection, the rotating cover 41 rotates to the first blocking portion 412 to block the first airway 1001, and at this time, the second blocking portion 413 does not block the second airway 1002 any more, and the second airway 1002 is opened. Further, sealing rings can be installed on the side of the first blocking portion 412 facing the first airway 1001 and the side of the second blocking portion 413 facing the second airway 1002, respectively, so as to achieve good air tightness during blocking.

As shown in FIGS. 2 to 6, in a specific embodiment, the airway switching assembly 40 includes a second elastic member 42, which is installed between the first blocking portion 412 and the cyclone separation structure 12; the airway switching assembly 40 also includes a top contact member 43, one end of which is connected to the second blocking portion 413; the second elastic member 42 is configured to lift up the first blocking portion 412 in response to the separation of the dust suck assembly 10 from the dust collecting assembly 20; the top contact member 43 is configured to lift up the second blocking portion 413 in response to the right connection of the dust suck assembly 10 and the dust collecting assembly 20. Thus, during vacuum, the dust suck assembly 10 and the dust collecting assembly 20 are separated, and the second elastic member 42 applies an elastic force on the first blocking portion 412, which can lift the first blocking portion 412 to open the first airway 1001, and the second blocking portion 413 blocks the second airway 1002 downward. After the dust collecting assembly 10 and the dust collecting assembly 20 are rightly connected, the top contact member 43 can overcome the elastic force of the second elastic member 42 to lift the second blocking portion 413 to open the second airway 1002, and the first blocking portion 412 blocks the first airway 1001 under the pressure of the top contact member 43. The second elastic member 42 and the top contact member 43 respectively applies a force on the rotating cover 41 to achieve blocking, which is easy to operate. For example, the second elastic member 42 can be a spring, and the top contact member 43 can be a top rod. In other embodiments, other parts can be selected according to actual conditions, as long as the above effects are achieved.

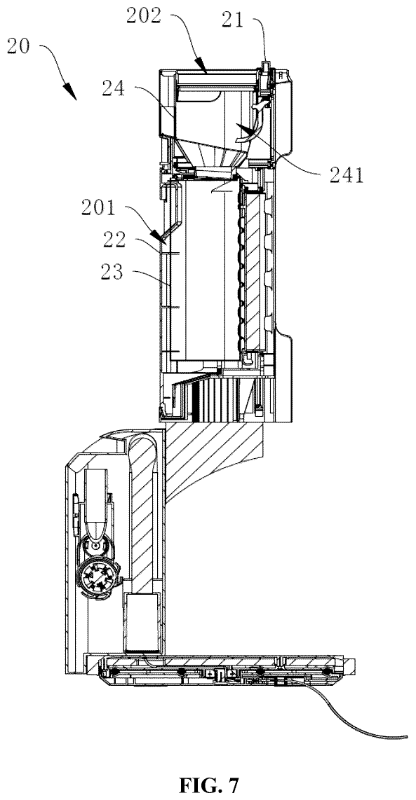

As shown in FIGS. 2 and 7, in a more specific embodiment, the dust collecting assembly 20 is also provided with a second abutting portion 21. During dust collection, the second abutting portion 21 abuts against the top contact member 43. In this way, during dust collection, the dust suck assembly 10 needs to be rightly connected with the dust collecting assembly 20 to collect the dust in the dust cup 11 into the second dust collecting chamber 201. Specifically, the second abutting portion 21 can be configured to be convexly arranged on the end surface of the dust collecting assembly 20 facing the dust suck assembly 10. With such arrangement, when right connection is performed, the second abutting portion 21 convexly arranged on the rightly connected end surface can push the top contact member 43 upward, and the top contact member 43 then transmits the force to the second blocking portion 413, thereby realizing the opening of the second airway 1002. Exemplarily, the second abutting portion 21 can be set as a protruding block, a spring, etc., and it is only necessary to push the top contact member 43 upward.

As shown in FIG. 7, in an optional embodiment, the dust collecting assembly 20 includes a dust collecting shell 22 and a dust collecting bag 23, the space in the dust collecting shell 22 forms a second dust collecting chamber 201, the dust collecting bag 23 is installed in the second dust collecting chamber 201, and the dust collecting bag 23 is configured to collect dust in the dust cup 11. Thus, the dust collecting shell 22 is arranged to facilitate dust suck in the second dust collecting chamber 201, the dust collecting bag 23 is arranged to facilitate dust collecting, and the air can pass through the dust collecting bag 23.

As shown in FIG. 7, in a specific embodiment, the dust collecting assembly 20 includes a dust collecting body 24, the dust collecting body 24 interconnects with the dust collecting assembly 10, and the dust collecting body 24 is provided with a collecting chamber 241, and the collecting chamber 241 is in communication with the second dust collecting chamber 201. After the cover 112 is opened, the first dust collecting chamber 101 can be in communication with the second dust collecting chamber 201 through the collecting chamber 241. The dust collecting body 24 is equipped with a dust collecting bag 23 at the opening of the collecting chamber 241, so that the dust falls into the dust collecting bag 23 from the first dust collecting chamber 101 through the collecting chamber 241.

### Second Embodiment

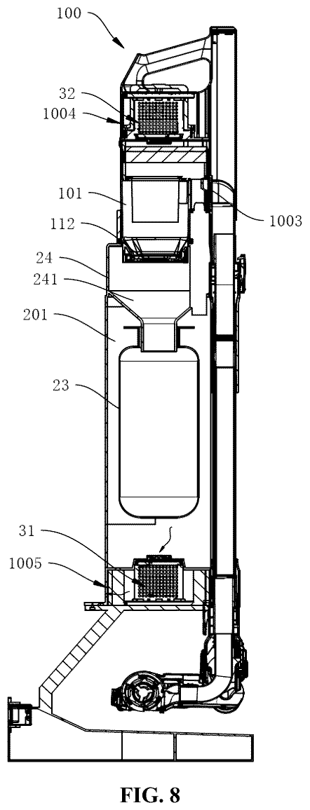

As shown in FIG. 8, the difference between the second embodiment and the first embodiment is that the first suck power source 31 is provided in the dust collecting assembly 20, and the dust suck assembly 10 further includes a second suck power source 32, which is configured to communicate the external air with the first dust collecting chamber 101. That is, the first suck power source 31 in Embodiment 2 only sucks the air in the second dust collecting chamber 201, and the dust suck assembly 10 sucks the external air with dust through the second suck power source 32. In this way, the first suck power source 31 and the second suck power source 32 can suck the air independently, and the operation is simple. Specifically, the first suck power source 31 is provided at the bottom of the dust collecting shell 22, avoiding the dust collecting bag 23. At the same time, a filter cotton can be arranged outside the exhaust port of the first suck power source 31 to filter the air, so that the air is discharged cleanly and dust is reduced. The filtered air flows out from the second air outlet 1005.

In this embodiment, when the first suck power source 31 extracts the air in the second dust collecting chamber 201, the air inlet is closed, and the cover 112 is opened under the action of the air pressure in the first dust collecting chamber 101, and the air in the first dust collecting chamber 101 rushes into the second dust collecting chamber 201 with the dust, so as to achieve the first dust collecting. After the cover 112 is opened, the air inlet is also opened, and the second suck power source 32 sucks the external air from the air inlet. The external air passes through the dust cup 11 and drives the remaining dust into the second dust collecting chamber 201 to achieve the second dust collecting, which is conducive to improving the dust collecting efficiency. In addition, such a setting can also realize dust suck at the same time as the secondary dust collecting. When the external air enters the dust suck assembly 10, it also brings the external dust into the dust suck assembly 10, and the external dust and the original dust in the first dust collecting chamber 101 enter the second dust collecting chamber 201 together.

In this embodiment, there is no need to additionally set up the second airway 1002, the airway switching assembly 40 and the return airway 1006, which is conducive to maintaining the original structure of the dust suck assembly 10. In addition to the above content, the content of the second embodiment is roughly the same as that of the first embodiment, and the first embodiment can be referred to, and no further description is given here.

### Third Example

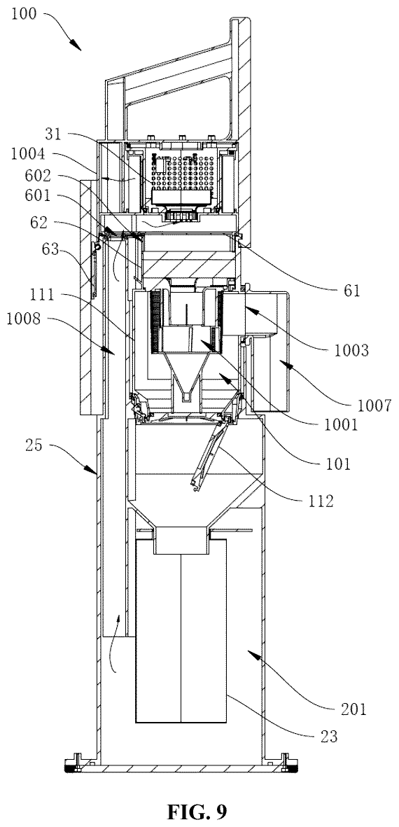

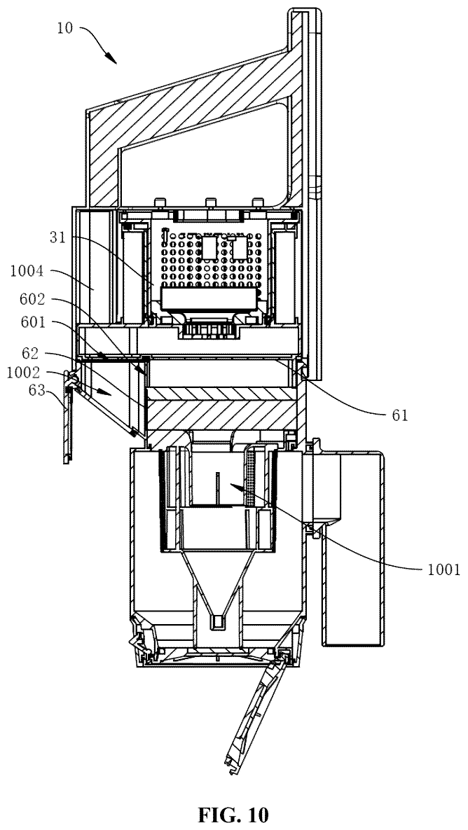

As shown in FIGS. 9 and 10, the difference between this application and the first embodiment is that the structure of the airway switching is different. In this embodiment, the dust suck assembly 10 includes a first shielding structure 61, a second shielding structure 62 and a sealing plate 63, and the first shielding structure 61 and the second shielding structure 62 are angled. The first shielding structure 61 is disposed between the dust cup 11 and the first suck power source 31, and can block the airflow along the axial direction of the dust cup 11 in the first airway 1001. The first shielding structure 61 is provided with a first flow opening 601 at a position opposite to the second airway 1002, and the airflow in the second airway 1002 can enter the first suck power source 31 through the first flow opening 601; the second shielding structure 62 is disposed between the first airway 1001 and the second airway 1002, and can block the airflow along the radial direction of the dust cup 11. The first shielding structure 61 and the second shielding structure 62 are provided with a second flow opening 602, and the first airway 1001 and the second airway 1002 can circulate through the second flow opening 602.

Furthermore, the sealing plate 63 can block the opening of the second airway 1002 away from the first circulation port 601, and open when the dust suck assembly 10 and the dust collecting assembly 20 are rightly connected. The dust collecting assembly 20 also includes a connecting pipe 25, and the space in the connecting pipe 25 forms a third airway 1008. The third airway 1008 is in communication with the second dust collecting chamber 201. After the dust collecting assembly 10 and the dust collecting assembly 20 are rightly connected, the connecting pipe 25 extends into the second airway 1002, and along its own axial end away from the second dust collecting chamber 201 is blocked at the second circulation port 602, and is in communication with the first circulation port 601. In a specific embodiment, a seal is provided between the connecting pipe 25 and the first shielding structure 61 to achieve sealing between the connecting pipe 25 and the first shielding structure 61, thereby preventing air leakage from occurring at the first circulation port 601.

During the dust suck stage, the first suck power source 31 can inhale external air through the first circulation port 601, the second circulation port 602 and the air inlet 1003, and the external air enters the first airway 1001 from the air inlet 1003, and the air and dust are separated in the first airway 1001, and the dust falls into the dust cup 11. The air separated from the dust passes through the second circulation port 602, the second circulation port 602 and the first suck power source 31, and finally flows out from the first air outlet 1004.

During dust collection, the dust suck assembly 10 and the dust collecting assembly 20 are rightly connected, and the sealing plate 63 is opened. At this time, the first airway 1001 is blocked by the connecting pipe 25, and the cover 112 is in a closed state. The first suck power source 31 can extract the air in the second dust collecting chamber 201 through the first flow port 601 and the third airway 1008, so that the second dust collecting chamber 201 is in a negative pressure state, so that the air in the first dust collecting chamber 101 unlocks the cover 112 through the air pressure and rushes out of the first dust collecting chamber 101, so as to bring the dust into the second dust collecting chamber 201. After the air is separated from the dust in the second dust collecting chamber 201, it can pass through the third airway 1008, the second airway 1002, the first flow port 601 and the first suck power source 31 in sequence, and finally be discharged from the first air outlet 1004.

In the embodiment of the present application, the second airway 1002 is a passage between the dust cup 11 and the shell of the dust suck assembly 10. Specifically, one end of the sealing plate 63 is rotatably connected to the shell, and the other end is snap-fitted to the dust cup 11. The dust collecting assembly 20 is provided with a push plate. When the dust suck assembly 10 and the dust collecting assembly 20 are rightly connected, the push plate can push the sealing plate 63 to unlock the sealing plate 63.

Except for the above content, the content of the second embodiment is roughly the same as that of the first embodiment, and can refer to the first embodiment, which is not be repeated here.

The present application also provides a dust collecting method, which is applied to the above-mentioned cleaning device; the dust collecting method includes: right connecting the dust collecting assembly 20 with the dust suck assembly 10; the first suck power source 31 sucks the air in the second dust collecting chamber 201 of the dust collecting assembly 20 to form a negative pressure in the second dust collecting chamber 201; the cover 112 is opened under the triggering of the negative pressure, and the first dust collecting chamber 101 and the second dust collecting chamber 201 are connected.

In this way, by discharging the air from the second dust collecting chamber 201 to form a negative pressure in the second dust collecting chamber 201, the cover 112 is opened, and the air in the first dust collecting chamber 101 can drive the dust in the first dust collecting chamber 101 into the second dust collecting chamber 201. Under the action of the air pressure, the dust can be concentrated and rushed into the second dust collecting chamber 201, which is conducive to improving the efficiency of dust collecting.

Specifically, the first suck power source 31 sucks the air in the second dust collecting chamber 201 of the dust collecting assembly 20 to form a negative pressure in the second dust collecting chamber 201, including: forming a pressure difference between the first dust collecting chamber 101 and the second dust collecting chamber of the dust suck assembly 10, the air pressure in the first dust collecting chamber 101 is greater than the air pressure in the second dust collecting chamber 201, that is, a pressure difference is generated between the two, and when the pressure difference reaches the first pressure difference, the air pressure in the first dust collecting chamber 101 can open the cover 112.

In some embodiments, when the pressure difference between the first dust collecting chamber 101 and the second dust collecting chamber 201 is set to 4 kPa, the air in the first dust collecting chamber 101 has sufficient air pressure to open the cover 112. In other embodiments, the corresponding pressure difference value can also be set according to the conditions for opening the cover 112, which is not specifically limited here. Furthermore, the first suck power source 31 can perform multiple sucks on the air in the second dust collecting chamber 201 to gradually reach an ideal pressure difference value. For example, after the first suck power source 31 is turned on and operated for a first period, the first suck power source 31 enters a standby state. After the second standby time, the first suck power source 31 continues to suck for the first period, and so on, until the start-up and standby actions are repeated n times and then terminated. Wherein, n≥2, n is an integer, for example, n can be set to 2, 3 or 4, as long as the set pressure difference value is satisfied.

In a further embodiment, the dust collecting method further includes: before the cover 112 is opened, the air inlet 1003 of the dust suck assembly 10 is closed; after the cover 112 is opened, the air inlet 1003 is opened, and the air inlet 1003 is in communication with the first dust collecting chamber 101 and the second dust collecting chamber 201.

In this way, before the cover 112 is opened, the air inlet 1003 is closed to make the cleaning device in a closed state, which is conducive to the centralized suck of the air in the second dust collecting chamber 201, so that the second dust collecting chamber 201 quickly reaches a negative pressure state. After the cover 112 is opened by the air in the first dust collecting chamber 101, the air inlet 1003 is opened, and the external air can be sucked into the cleaning device at this time, and the remaining dust at the bottom of the first dust collecting chamber 101 is further flushed into the second dust collecting chamber 201, further improving the dust collecting effect.

The present application also provides a dust collecting method, which is applied to a cleaning device 100, and the cleaning device 100 is provided with a first dust collecting chamber 101 and a second dust collecting chamber 201 which are selectively communicated, and the cleaning device 100 includes a dust cup 11, and the dust cup 11 forms the first dust collecting chamber 101. The dust collecting method includes: suck air in the second dust collecting chamber 201 to form a negative pressure in the second dust collecting chamber 201; the cover 112 of the dust cup 11 is opened under the negative pressure, and the first dust collecting chamber 101 is in communication with the second dust collecting chamber 201.

In this way, by discharging the air out of the second dust collecting chamber 201 to form a negative pressure in the second dust collecting chamber 201, the cover 112 is opened, and the air in the first dust collecting chamber 101 can drive the dust in the first dust collecting chamber 101 into the second dust collecting chamber 201. Under the action of the air pressure, the dust can be concentrated and rushed into the second dust collecting chamber 201, which is conducive to improving the efficiency of dust collecting.

Specifically, that suck the air in the second dust collecting chamber 201 to form a negative pressure in the second dust collecting chamber 201 includes: forming a pressure difference between the first dust collecting chamber 101 and the second dust collecting chamber 201, the air pressure in the first dust collecting chamber 101 is greater than the air pressure in the second dust collecting chamber 201, that is, a pressure difference is generated between the two, and when the pressure difference reaches the first pressure difference, the air pressure in the first dust collecting chamber 101 can open the cover 112.

In a further embodiment, the cleaning device 100 is provided with an air inlet 1003 in communication with the first dust collecting chamber 101, and the dust collecting method further includes: before the cover 112 is opened, the air inlet 1003 of the dust suck assembly 10 is closed; after the cover 112 is opened, the air inlet 1003 is opened, and the air inlet 1003 is in communication with the first dust collecting chamber 101 and the second dust collecting chamber 201.

In this way, before the cover 112 is opened, the air inlet 1003 is closed to put the cleaning device in a closed state, which is conducive to the centralized suck of the air in the second dust collecting chamber 201, so that the second dust collecting chamber 201 quickly reaches a negative pressure state. After the cover 112 is opened by the air in the first dust collecting chamber 101, the air inlet 1003 is opened, and the external air can be sucked into the cleaning device 100, and the remaining dust at the bottom of the first dust collecting chamber 101 is further flushed into the second dust collecting chamber 201, further improving the dust collecting effect. The technical features of the above-mentioned embodiments can be combined arbitrarily. In order to make the description concise, all possible combinations of the technical features in the above-mentioned embodiments are not described. However, as long as there is no contradiction in the combination of these technical features, they should be considered as the scope of this specification.

The above-mentioned embodiments only express several implementation methods of the present application, and the description is relatively specific and detailed, but it cannot be understood as a limitation on the scope of the patent application.

It should be pointed out that for ordinary technicians in this field, without departing from the concept of the present application, several modifications and improvements can be made, which all belong to the protection scope of the present application. Therefore, the protection scope of the patent of this application shall be based on the attached claims.

We claim:

1. A cleaning device, comprising:
a dust suck assembly having a dust cup, wherein the dust cup comprises a cup body and a cover movably connected to the cup body, and the cup body and the cover constitute a first dust collecting chamber;
a dust collecting assembly having a second dust collecting chamber; and
a first suck power source, arranged on the dust suck assembly or the dust collecting assembly and configured to generate negative pressure in the second dust collecting chamber, and the cover configured to open relative to the cup body under triggering of the negative pressure to interconnect the first dust collecting chamber with the second dust collecting chamber, wherein the dust cup interconnects with the second dust collecting chamber during dust collection.

2. The cleaning device according to claim 1, wherein along a radial direction of the dust cup, the cover has a first end and a second end which are arranged opposite to each other, the first end movably connected to the cup body, and the second end configured to open relative to the cup body under the triggering of the negative pressure.

3. The cleaning device according to claim 2, wherein the first end is rotatably connected to the cup body, the second end snap-fitted to the cup body, the second end configured to be disengaged from the cup body in response to a pressure difference between the first dust collecting chamber, and the second dust collecting chamber reaching a first pressure difference.

4. The cleaning device according to claim 3, wherein the dust suck assembly comprises a locking mechanism, the locking mechanism being rotatably connected to the cup body, the locking mechanism comprising an elastic portion and a first abutting portion which are spaced apart, the elastic portion and the first abutting portion arranged at two ends of a rotating shaft of the locking mechanism, the elastic portion elastically connected to the cup body, and the first abutting portion snap-fitted to the cover.

5. The cleaning device according to claim 4, wherein the first abutting portion has an abutting surface, the cup body is radially and axially angled with the abutting surface, the cover has a mating surface, wherein the mating surface is configured to fit on the abutting surface to be locked, and the abutting surface is configured to rotate around the rotating shaft in response to a first pressure difference to move away from the mating surface.

6. The cleaning device according to claim 5, wherein during the dust collection, an air inlet of the dust suck assembly is configured to open in response to an opening of the cover, and the air inlet is allowed to interconnect with the first dust collecting chamber and the second dust collecting chamber.

7. The cleaning device according to claim 1, wherein the first suck power source is provided in the dust collecting assembly;
the dust suck assembly comprises a first airway and a second airway, the first airway being located in the dust cup, and the second airway located outside the dust cup;
wherein the air inlet of the dust collecting assembly, the first airway, the first suck power source and the first air outlet of the dust suck assembly are interconnected during vacuum; the second dust collecting chamber, the second airway, the first suck power source and the first air outlet are interconnected during the dust collection.

8. The cleaning device according to claim 7, wherein the dust suck assembly comprises an airway switching assembly, the airway switching assembly is installed between the first airway and the second airway, and the airway switching assembly is configured to switch one of the first airway and the second airway to open and the other to close.

9. The cleaning device according to claim 8, wherein the airway switching assembly comprises a rotating cover, the rotating cover has a rotating shaft, and a portion located on one side of the rotating shaft along the radial direction of the rotating shaft is defined as a first blocking portion, and a portion located on the other side is defined as a second blocking portion; wherein the first blocking portion is configured to block the first airway, and the second blocking portion is configured to block the second airway, and the rotating cover is configured to switch between the first blocking portion and the second blocking portion by rotating around the rotating shaft.

10. The cleaning device according to claim 9, wherein the cleaning device comprises a cyclone separation structure, the cyclone separation structure is installed in the dust cup, an inner cavity of the cyclone separation structure being in communication with the dust cup and forming the first airway, wherein a channel between the dust cup and the air inlet serves as the second airway.

11. The cleaning device according to claim 10, wherein the airway switching assembly comprises a second elastic member, the second elastic member is installed between the first blocking portion and the cyclone separation structure, wherein the airway switching assembly further comprises a top contact member, one end of which is connected to the second blocking portion, wherein the second elastic member is configured to lift up the first blocking portion in response to a separation of the dust suck assembly from the dust collecting assembly, and wherein the top contact member is configured to lift up the second blocking portion in response to connection of the dust suck assembly to the dust collecting assembly.

12. The cleaning device according to claim 11, wherein the dust collecting assembly is further provided with a second abutting portion, and the second abutting portion abuts against the top contact member during the dust collection.

13. The cleaning device according to claim 1, wherein the first suck power source is provided in the dust collecting assembly, and the first suck power source is in communication with a second air outlet of the dust collecting assembly.
